(19) United States
(12) Patent Application Publication
(10) Pub. No.: US 2013/0286407 A1
(43) Pub. Date: Oct. 31, 2013

(54) APPARATUS

(71) Applicants: Daniel Elson, London (GB); Neil Clancy, London (GB); Guang-Zhong Yang, Surrey (GB); Danail Stoyanov, London (GB)

(72) Inventors: Daniel Elson, London (GB); Neil Clancy, London (GB); Guang-Zhong Yang, Surrey (GB); Danail Stoyanov, London (GB)

(21) Appl. No.: 13/458,336

(22) Filed: Apr. 27, 2012

(51) Int. Cl. G01B 11/24; F21V 8/00

(52) U.S. Cl. 356/602; 362/559; 356/601

(57) ABSTRACT

An apparatus for illuminating an object with electro-magnetic radiation comprising spectrally distinct features, the apparatus comprising:
a) a probe for illuminating the object and having a proximal end and a distal end;
b) a receiver for receiving reflected light from the object; and
c) a processor operatively connected to the receiver for processing the reflected light,
wherein the probe comprises a bundle of waveguides, each of which waveguides transmits light of a particular wavelength, wavelength band or spectrum.

This invention relates to an apparatus for measuring the three dimensional (3D) surface shape of an object such as a tissue, particularly during minimal invasive surgery (MIS).

Recovering the 3D surface shape of tissues in MIS is important for developing advanced image-guidance and navigation systems.

It can be important to be able to determine the 3D surface shaped tissues, since the shape of tissues is frequently used as an initial diagnostic indicator in the clinic. In the skin, swelling size, scar depth or surface roughness are important indicators of disease progression and treatment efficacy, but are subject to the clinician's experience.

Surface morphology is also important in the field of MIS. An accurate 3D map of the surgical environment could allow the combination of pre-operative images (such as MRI scans) with the “live” view, helping in the localisation and excision of tumours. Also, a 3D map of the operating environment could aid navigation of robots designed for new “scarless” techniques in MIS.

It is known to use structured light techniques to recover 3D information about an object by illuminating it with light having a particular pattern and then monitoring the deformation of the light that is reflected back from the object, with a camera. While such systems have found applications in industrial machine vision, a number of problems have slowed its use in the biomedical field. These problems include limitations on illumination strength, difficulty in analysing dense patterns, miniaturisation (for endoscopy) and the desire for normal “white light” views of a tissue to remain undisturbed.

Particular problems exist in relation to the determination of the surface shape of tissues. For example, known passive techniques based on computational stereo are limited by the saliency of tissue texture and the view-dependent reflectance characteristics of the scene.

It is known to use techniques involving the projection of structured light patterns onto objects in order to determine the 3D shape of the object. Such techniques provide a viable alternative by projecting known features onto the tissue surface.

However, a problem exists in being able to distinguish the individual projected features computationally. This problem is known as the correspondence problem and becomes prominent in tissue due to the presence of occlusions.

In addition, if the technique is required to be used during MIS, it is necessary to miniaturise the light projection system used in order that it may have dimensions that enable it to be used with MIS instruments. For example, being small enough to fit inside endoscopic biopsy channels. Such miniaturisation can make it difficult to maintain an appropriate light intensity.

The expansion of minimally invasive surgery (MIS) into more challenging domains has meant that knowledge of the 3D structure of the tissue surface is becoming increasingly more valuable. For example, in robotic surgery there is greater demand for improved visualisation of tissue to perform complex navigational tasks and to aid in registration of pre-operative images with the surgeon's current view as part of an augmented reality system.

In surgery, stereo reconstruction can be used in stereo-laparoscopic systems to recover depth information. However, this method relies on finding and matching image points between two cameras based on measures of similarity and salience, which may not be present in images of tissue with homogeneous characteristics. The use of structured light patterns avoids this problem by projecting features onto the surface and finding their location in 3D space by triangulating the known projection paths of those light rays with the corresponding rays reflected back into a camera.

In order to overcome the “correspondence problem” mentioned hereinabove, the structured light pattern must be encoded so that the features that are projected onto the surface, the shape of which is to be determined, are uniquely identifiable regardless of pattern density or the occlusion of individual feature points.

According to a first aspect of the present invention there is provided an apparatus for illuminating an object with electro-magnetic radiation comprising spectrally distinct features, the apparatus comprising:
a) a probe for illuminating the object and having a proximal end and a distal end;
b) a receiver for receiving reflected light from the object; and
c) a processor operatively connected to the receiver for processing the reflected light,
wherein the probe comprises a bundle of waveguides, each of which waveguides transmits light of a particular wavelength, wavelength band or spectrum.

A feature is defined as being spectrally distinct if it has a different wavelength to one or more other features in the electromagnetic radiation used to illuminate the object, or if it has a different dominant, or average wavelength, or if it has a different wavelength band or spectrum to one or more of the other features.

The electromagnetic radiation used to illuminate the object may have any convenient wavelength range, and in many embodiments of the invention, the electromagnetic radiation may fall within the visible range of the electromagnetic spectrum.

The invention will be further described herein with reference to “light”. It is to be understood however that the radiation used to illuminate the object could have any convenient wavelength or wavelength range and is not necessarily restricted to visible wavelengths.

The waveguides may take any convenient form, and may be in the form of optical fibres.

The apparatus may comprise a spectrally dispersed or spectrally distinct light source optically connected to the proximal end of the probe. Such a light source is known as a spectrally encoded light source.

In some embodiments, this spectrally encoded light source comprises a collimated light source coupled with a disperser for spectrally dispersing the collimated light produced by the collimated light source.

The waveguides may have any particular configuration, and in some embodiments the waveguides are arranged substantially linearly, or in a one dimensional array, at the proximal end of the probe.

This means that using suitable alignment techniques and an appropriate light source, the spectrally dispersed or spectrally distinct light produced by the spectrally encoded light source will be incident on the plurality of optical fibres such that each of the fibres receives light from the light source having a different spectral content to the light received by one or more of the other fibres. In this way, light transmitted by the probe and used to illuminate the object is spectrally encoded.

In some embodiments of the invention the light carried by each waveguide has a different spectral content to that of all other waveguides, whereas in other embodiments some waveguides may carry light with the same spectral content as at least one other waveguide.

The term spectral encoding as used in this specification means that light from different features may be distinguished according to the wavelengths present. This may be a single wavelength, a wavelength band or bands, or uniquely distinguishable spectra for example.

The waveguides may be bundled together. In some embodiments they assume a hexagonal packing formation although other formations are possible. This formation may be present at the distal end of the probe.

The waveguides may be bundled together in a random fashion which means that the spectrally encoded light conducted by each of the waveguides assumes a random position within the bundle.

The waveguides may also be coherently arranged so that specific wavelengths, wavelength bands or spectra have a recognisable spatial arrangement at the distal end of the probe.

The apparatus may comprise a lens for forming an image of the distal end of the probe on the object.

This means that, in embodiments of the invention where the waveguides assume a hexagonal packing formation at the distal end of the probe, light rays, or beams of light having a corresponding formation will be projected onto the image, each of which beams or rays or light has a spectrally distinct content from one or more other rays or beams of light projected onto the object.

The receiver may take any convenient form, and may, for example, comprise a digital colour camera adapted to record the image produced by the incident light on the object by means of a plurality of camera pixels.

The probe may comprise a high speed shutter that may be synchronised with the camera so that the structured light will be visible for a small number of frames every second. In such an arrangement the structured light pattern should not interfere with the surgeon's view.

In some embodiments of the invention it may be possible to extract the 3D data based on the detected spot position without the need to use a calibrated camera.

The 3D data may be obtained from the aspect ratio of the projected spots themselves. When incident normally on a planar object, each spot is circular. However, once an object is tilted or otherwise deformed, the spot shape changes. The aspect ratio of the resulting ellipsoidal shape and the angle that its major axis makes with the vertical could be used to infer the local orientation of the surface and to calculate the direction of the surface normals.

The processor is adapted to transform data from the image so formed into a format suitable for readily understanding the shape of the object.

In embodiments of the invention in which the receiver comprises a digital camera, the processor is adapted to transform the image formed in the camera by transforming each pixel from RGB space into CIE xy coordinates; calculating an associated wavelength or spectrum of each pixel; and identifying areas of similar spectrum and isolating those areas.

In other embodiments of the invention the characteristic colour properties of each pixel may be determined using other methods.

An apparatus according to embodiment of the invention, and as described hereinabove is highly flexible and creates light of sufficient intensity for use in endoscopic surgical procedures. In embodiments of the invention in which the light source at the proximal end is a supercontinuum laser, the spectrum of each projected feature (or spot) has a narrow profile and is located close to the spectrum locus of the CIE 1931 diagram. Wavelength based identification and discrimination of specific dots is possible regardless of background colour using only the RGB output from the camera, which may be compatible with colour cameras widely used in surgery, including endoscope cameras.

In an alternative embodiment of the invention, the probe comprises a waveguide extending along the length of the probe, and the apparatus further comprises a pattern generator operatively coupled to the distal end of the probe.

The pattern generator may take any convenient form, and may for example comprise a refractive optical element.

An apparatus according to embodiments of the invention has particular application in respect of determining the 3D shape of a tissue.

However, as explained in more detail hereinbelow, an apparatus according to embodiments of the invention may be used in other ways.

The probe forming an apparatus according to embodiments of the invention may have any suitable dimensions, although when the probe is used an endoscope probe, it will typically have a diameter of sub millimetre to a few millimetres.

Embodiments of the invention using near infrared output such as from a supercontinuum laser, could be used in conjunction with a suitable camera to provide “invisible” structured illumination that would not interfere with the surgeon's view.

In other words, the invention may be used with near infrared electromagnetic radiation, which radiation is not visible to the human eye and therefore would not distract a surgeon during a medical procedure.

When a probe according to embodiments of the invention is placed in vivo, it may form part of a therapeutic light delivery system capable of varying a dose of light delivered spatially.

In other embodiments of the invention adapted to measure the 3D surface of an object, the light intensity in specific fibres could be adjusted to account for the local shape of the tissue and the corresponding surface normals.

Gold nanoparticle-mediated photothermal therapy of tumours is an example where this may be possible by directing more light to areas of tissue containing nanoparticles.

Alternatively, or in addition, embodiments of the invention may have applications in the control of light during photodynamic therapy dosing by integrating some form of intensity control such as a liquid crystal tunable filter. This will enable the targeting of light treatment with a high spatial precision and efficiency without the need to manually move an irradiated point probe to specific areas.

During photodynamic therapy, a targeted drug/chemical accumulates in diseased tissue. When the tissue is illuminated with light, a chemical reaction occurs that results in local tissue destruction. The tissue is therefore killed by selective application of both a chemical and also light. The structured light probe can be used to deliver light to certain target regions of the tissue only, by controlling which fibres the light is coupled into at the proximal end.

A further advantage of the invention is that since the probe will be fully calibrated in metric space, it will be capable of returning absolute measurements of distance between points on the tissue in the illuminated area.

In a known technique, a projector-camera pair will be used to illuminate and image a planar calibration object with a printed pattern. The printed pattern may for example comprise a checker board or dot array of known dimensions.

Images will be acquired with the calibration object at different distances and orientations with respect to the camera. These images can be used to trace the path of the light rays for each spot by finding the best fit straight line in 3D space through each spot.

The calibration routine will allow the relationship between the projected ray, reflected ray (as imaged by the camera) and point of intersection to be related by means of a matrix equation.

This process is equivalent to the process of 3D reconstruction from stereo views of an object, with the projector considered as an “inverse camera”.

If the probe is used with a flexible endoscope or some other imaging instrument for intralumenal examination, it will be possible to perform initial assessments of various structures such as polyps and determine whether or not they may be significant. Analysis of polyp morphology is an indicator of pathology, and the shape of crypts in the surface has been correlated to histological results after manual inspection. By quantifying these so-called ‘pit patterns’ by 3D surface measurement however, it may be possible to classify them according to type automatically and use this information to guide and assist biopsy.

According to a second aspect of the present invention there is provided a method for determining the shape of an object comprising the steps of:
a) illuminating the object with electro-magnetic radiation comprising spectrally distinct features to form an image;
b) receiving reflected light from the image;
c) determining the shape of the object from data generated from the reflected light.

The step of determining the shape of the object may comprise the steps of:
a) receiving data from the image in the form of pixels in RGB space;
b) converting the RGB space data in to CIE xy coordinates;
c) calculating an associated wavelength of each pixel; identifying areas of constant wavelength and isolating those areas.
d) matching each spot with a corresponding ray in a calibrated dataset for 3D triangulation.

Step b) identified above may be replaced with a different step used to determine the location of the spots.

The invention will now be further described by way of example only in which:

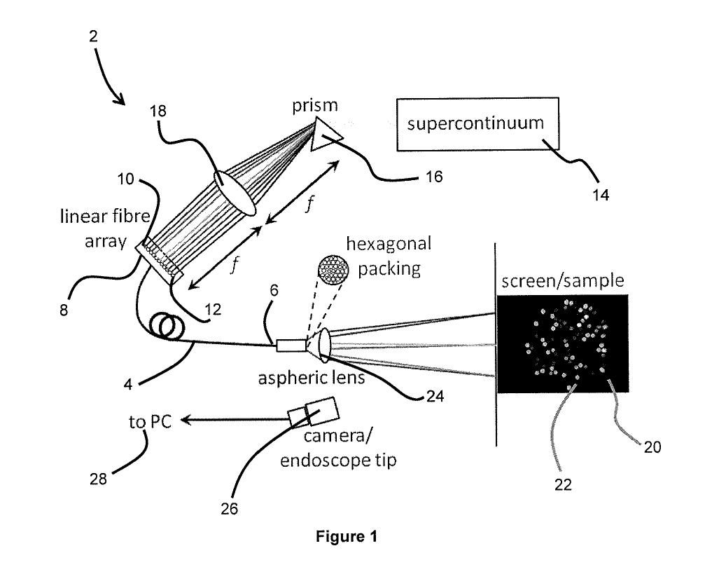

FIG. 1 is a schematic representation of an apparatus according to an embodiment of the invention;

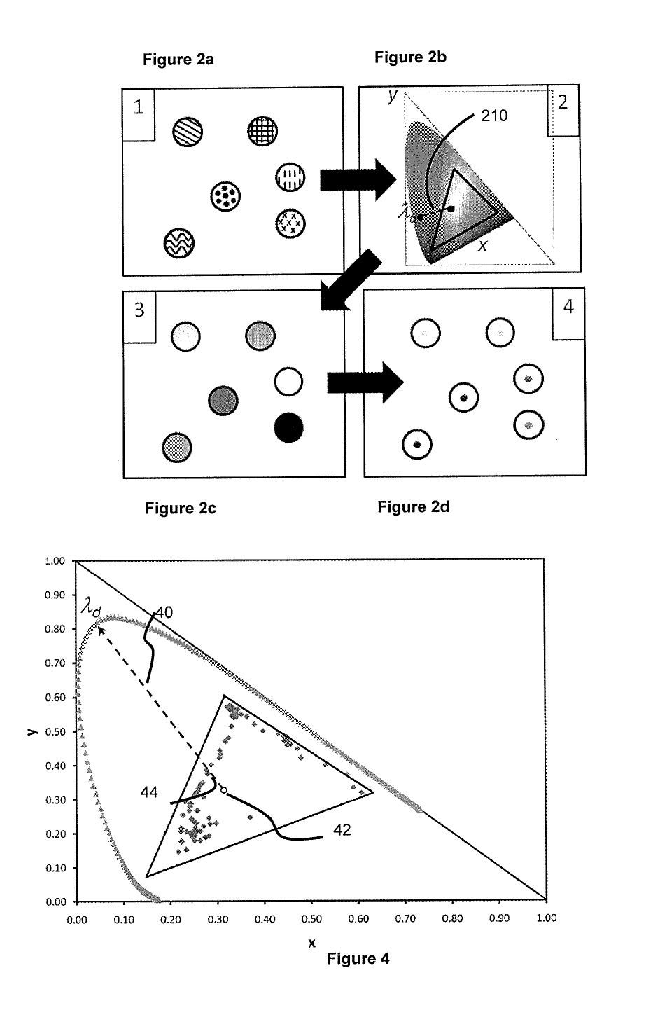

FIGS. 2a to 2d are schematic representations showing how the data received by a camera, forming part of the apparatus of FIG. 1, is processed to form an image comprising spots representing areas having a constant wavelength or wavelength range;

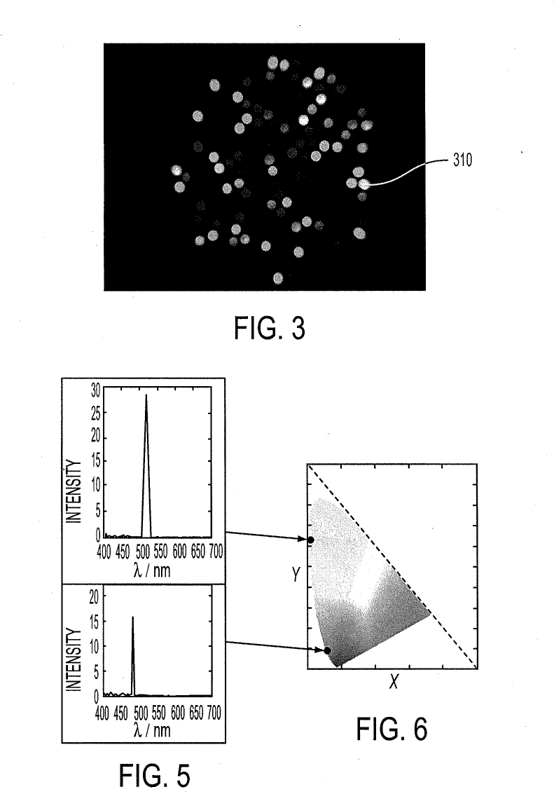

FIG. 3 is a schematic representation showing in more detail the RGB image formed when the object is illuminated using the apparatus of FIG. 1;

FIG. 4 is schematic representation showing how a colour camera interprets the colour of each spot shown in FIG. 3;

FIG. 5 is a schematic representation showing example spectra of two different spots;

FIG. 6 is a schematic representation showing how the example spectra of two spots is represented in a CIE 1931 chromaticity diagram (xy space);

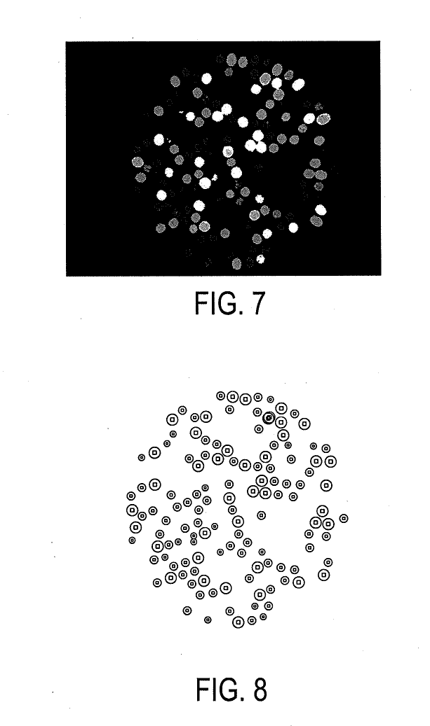

FIG. 7 is a graphical representation of the data once it has been mapped to λ space in which the wavelength range 380 to 700 nm has been scaled to greyscale values 0 to 255 for display;

FIG. 8 is a graphical representation showing the centroids of areas having a specific wavelength; and

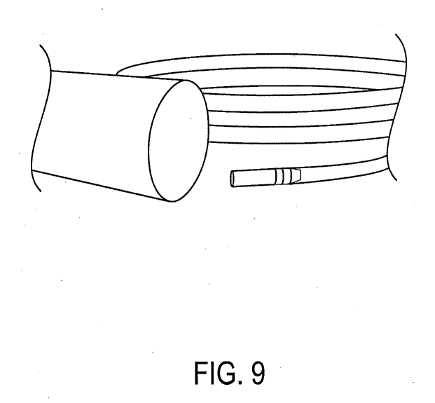

FIG. 9 is a schematic representation of a probe for use in the apparatus illustrated in FIG. 1.

An apparatus according to an embodiment of the invention as designated generally by the reference numeral 2. The apparatus may be used in order to determine the 3D shape of an object, and particularly of tissue. Such measurement may conveniently take place during a procedure known as minimally invasive surgery (MIS).

The apparatus comprises a probe 4 having a distal end 6 and a proximal end 8.

As used herein, the term “endoscope probe” is used to describe one or more parts for an endoscopic system which can be inserted a human or animal body in order to obtain an image of tissue within the body.

The probe 4 comprises a randomised bundle of 256 fibres 9 each having a core of approximately 50 μm, and an average separation of 68±3 μm. Of course, in other embodiments, the fibres may have a different average diameter of core and/or separation.

The proximal end 8 of the probe 4 is optically connected to a spot-to-line converter 10, which in this embodiment is from Romack Inc, USA. The apparatus further comprises a light source, which in this example is a supercontinuum laser 14 having a power of 4 watts. In this example the laser was obtained from Fianium Ltd, United Kingdom.

The collimated output from the laser 14 is directed onto a prism 16 which acts as a disperser, and disperses the light into the visible spectrum. This light is coupled to the end of the optical fibres which are arranged substantially linearly to form a one dimensional matrix 12.

An achromatic lens 18 having, in this example a focal length of 75 mm is used to focus the spectrum produced by the prism onto the line end 12.

By appropriate positioning of the prism 16 and lens 18, the dispersed light is directed onto each of the fibres forming the line array 12.

Because the light has been spectrally encoded, discrete beams of light having a narrow bandwidth will be produced and will be positioned spatially according to the wavelength of the waveband.

Since the probe comprises an incoherent bundle of fibres, the positions of the colours at the distal end 6 of the probe 4 are randomised, resulting in the mixed colour effect shown in the representation of the scene identified by the reference numeral 20 in FIG. 1.

As can be seen from FIG. 1, the light that is projected from the probe comprises a plurality of spots, or points 22, each of which spots corresponds to a unique colour or wavelength band, having a bandwidth of approximately 2 nm, and a central wavelength separation of approximately 1.4 nm between adjacent fibres in the bundle.

The apparatus further comprises an aspheric lens 24 at the distal end 6 of the probe. This lens focuses an image of the distal end of the probe 4 onto a sample, such as a sample of tissue, the shape of which is to be measured.

The image produced comprises a plurality of spots 22 positioned in RGB space as shown in FIG. 1 and also in. FIG. 2a. The patterns shown on spots in FIG. 2a represent different colours. FIG. 2a shows a schematic representation of the RGB image of the spot pattern acquired by the camera. This RGB system interprets each colour as occupying an xy coordinate within the triangular RGB space, which is a subset of the entire set of visible colours in the chromaticity diagram shown in FIG. 2b. FIG. 2b illustrates conceptually one method to determine the wavelength of a spot, as will be explained in more detail herein below. However, if a line is projected from the reference point of the RGB system (white point) through the xy representation of the spot's colour, it will intersect the so-called spectrum locus (colours corresponding to pure wavelengths in the visible range) of the chromaticity diagram at the spot's dominant wavelength λ_{d}. This is shown particularly in FIG. 2b and FIG. 4. Since each spot comprises a single wavelength only, λ_{d} will be the actual wavelength of that particular spot. The equivalent wavelength value of each RGB pixel in the image is found in this way. Clusters of similar wavelength value (with a tolerance of +/−1 nm) are grouped together at the location of each spot using a region-growing or equivalent algorithm. This means that each spot is now labelled in a greyscale space where the pixel values correspond to actual wavelengths as shown in FIGS. 2c and 7. Using a threshold algorithm it is then possible to cycle through the visible wavelength range and isolate each projected spot (or spots on a particular wavelength) so that its centroid may be computed as shown in FIGS. 2d and 8. Image filters are applied prior to thresholding to remove noise and prevent erroneous centroid detection. It is not required to spectrally determine the wavelength of each spot and other methods may also be used to distinguish the spots.

Further discussion on the calculation of 3D coordinates is set out below.

The apparatus further comprises a camera 26 positioned to be able to capture the image reflected by the sample in order that the image can be processed as explained in more detail hereinbelow. To this end, the camera 26 is operably connected to a processor, such as a computer 28.

The first stage of the processing is to convert on a pixel by pixel basis, the RGB values returned by the camera to the signal processor to the CIE 1931 XYZ colour space. This colour space represents colours by their relevant levels of the red, green and blue regions of the visible spectrum known as tristimulus values.

In this embodiment of the invention, the conversion is performed by multiplication by a 3×3 transformation matrix computed based on the RGB space and a standard illuminant.

This 3D space is then transformed to a 2D representation by normalising the X and Y components by the sum of the X, Y and Z to yield the corresponding coordinates of the CIE xy chromaticity diagram.

This diagram is shown in FIG. 2b where it can be seen that there is a straight line 210 that connects the xy coordinates with those of the standard illuminant, and this line intersects the spectrum locus (the line that bounds the visible colours) at the dominant wavelength λ_{d} present in that particular pixel.

In this way, each pixel of the image is converted from RGB to A space.

Since each of the pixels has a narrow bandwidth, the xy coordinates of each pixel will lie close to the spectrum locus.

Segmentation of the image into the approximately 180 uniquely coloured spots is then achieved using an algorithm that searches for patches of the image with the same wavelength using region-growing techniques (or equivalents) and records the coordinates of their centroids. Alternatively this segmentation may be carried out using the image intensity information recorded by the camera.

Turning now to FIGS. 3 to 7, the conversion of the data from RGB values to approximately 180 uniquely coloured spots is shown in more detail. The number of spots corresponds to the number of fibres in the probe. In other embodiments of the invention, the probe may be contain a different number of fibres and therefore there will be a different number of spots.

The projected spot pattern created by illuminating the sample to be measured with the light emitting from the probe 4 is shown again at FIG. 3. The pattern comprises a plurality of spots 310 as viewed on a flat white screen.

FIG. 4 shows schematically that a colour camera interprets the colour of each spot in FIG. 3 as a point with colour coordinates lying inside the triangular RGB space within the chromaticity diagram of all possible visible colours.

The curved spectrum locus mapping the boundary of the chromaticity diagram represents the colours of pure wavelengths.

Projecting a line 40 from the RGB reference point (white spot) 42 through the xy coordinate of a particular spot 44 yields the dominate wavelength λ_{d} for that spot at the point of inter-section the spectrum locus.

FIG. 5 shows how the spectrum of each spot (the spectrum of just two spots is shown in FIG. 4) represented in the CIE 1931 xy space in order to determine the dominant wavelength at each pixel. In FIG. 5 it can be seen that the dominant wavelength of a first pixel is just over 500 nm, and the dominant wavelength of a second pixel is just under 500 nm.

‘Pure’ wavelengths (spectra with a bandwidth of a few nm) such as those in FIG. 5 map to the spectrum locus of the CIE 1931 chromaticity diagram as shown in FIG. 6.

After converting each RGB pixel to λ-space (FIG. 7), an algorithm may then be used to segment the image into approximately 180 uniquely coloured spots by searching for patches of the image with the same wavelength and recording the coordinates of their centroids resulting in the image shown in FIG. 8.

The inventors have carried out experiments to ascertain whether the reflectivity of the sample affected the mapping of a particular spot from RGB to wavelength. In these experiments the RGB values were obtained using a white background and then obtaining the RGB values using red, green and blue backgrounds.

The inventors have found that the variation in predicted wavelength was only appreciable (up to ±10 nm) at the fringes of each spot where the intensity was lower, or in spots from poorly coupled fibres where the distribution of pixel values was less homogenous.

A measure of the spectral purity of each spot was obtained by calculating the ratio of the distance from the standard illuminant to the dominant wavelength coordinates (on the CIE 1931 diagram), and the standard illuminant to the calculated sample positions.

For the more complex case of biological tissue, a structured light pattern and algorithm used in accordance with embodiments of the invention were tested on a section of lambs kidney and chicken breast. Due to multiple scattering, the varying penetration depth of light and tissue and strong absorption at the blue end of the spectrum, the segmentation is more difficult although wavelength identification and centroiding is still possible.

An example of a probe suitable for use in the apparatus shown in FIG. 1 is shown in FIG. 9. This probe was made by FiberTech Optica, Inc, Canada. The probe has an outer diameter of 1.7 mm. In one embodiment of the invention a gradient index (GRIN) lens may be attached to the distal end of the probe to produce a magnified image of the distal end face, performing the same function as the lens 24 in FIG. 1.

A diameter of this order of magnitude (1.7 mm) will allow the probe to fit into the instrument channel of known flexible GI (gastrointestinal) endoscopes, rigid endoscopes and flexible robots, and used to interact with a tissue for any of the applications described hereinabove.

The invention has been described hereinabove with reference to the visible range of the electromagnetic spectrum. It is however to be understood that the invention may be used with different ranges of the electromagnetic spectrum, for example, the ultraviolet (UV) range, or the infrared including near infrared range.

### REFERENCES

1. Hartley R, Zisserman A. Multiple view geometry in computer vision. Cambridge University Press; 2000.

2. Zhang Z. A flexible new technique for camera calibration. IEEE T Pattern Anal. 2000: 22(11): 1330-4.

3. Geng J. Structured-light 3D surface imaging: a tutorial. Adv Opt Photon. 2011: 3(2): 128-60.

4. Kato S, Fu K I, Sano Y, Fujii T, Saito Y, Matsuda T, et al. Magnifying colonoscopy as a non-biopsy technique for differential diagnosis of non-neoplastic and neoplastic lesions. World J Gastroenterol. 2006: 12(9): 1416-20.

5. Schwartz J J, Lichtenstein G R. Magnification endoscopy, chromoendoscopy and other novel techniques in evaluation of patients with IBD. Tech Gastrointest Endosc. 2004: 6(4): 182-8.

1. An apparatus for illuminating an object with electro-magnetic radiation comprising spectrally distinct features, the apparatus comprising:
a) a probe for illuminating the object and having a proximal end and a distal end;
b) a receiver for receiving reflected light from the object; and
c) a processor operatively connected to the receiver for processing the reflected light,
wherein the probe comprises a bundle of waveguides, each of which waveguides transmits light of a particular wavelength, wavelength band or spectrum.

2. An apparatus according to claim 1 wherein one or more of the waveguides comprises an optical fibre.

3. An apparatus according to claim 2 comprising a spectrally dispersed or spectrally distinct light source optically connected to the proximal end of the probe.

4. An apparatus according to claim 3 wherein the light source comprises a collimated light source and a disperser for spectrally dispersing the collimated light.

5. An apparatus according to claim 4 wherein the waveguides are arranged in a substantially linear formation at the proximal end of the probe.

6. An apparatus according to claim 5 wherein the waveguides assume a hexagonal packing formation.

7. An apparatus for illuminating an object with electro-magnetic radiation comprising spectrally distinct features, the apparatus comprising:
a) a probe for illuminating the object and having a proximal end and a distal end;
b) a receiver for receiving reflected light from the object; and
c) a processor operatively connected to the receiver for processing the reflected light,
wherein the probe comprises a waveguide extending along the length of the probe, the apparatus further comprising a pattern generator, operatively coupled to the distal end of the probe.

8. An apparatus according to claim 7 wherein the pattern generator comprises a diffractive optical element.

9. An apparatus according to claim 7 further comprising a light source optically connected to the proximal end of the probe.

10. An apparatus according to claim 9 wherein one or more of the waveguides comprises an optical fibre.

11. An apparatus according to claim 10 further comprising a lens for forming an image of the distal end of the probe on the object.

12. An apparatus according to claim 11 wherein the receiver comprises a digital colour camera.

13. An apparatus according to claim 12 wherein the probe comprises a high speed shutter synchronised with the camera.

14. An apparatus according to claim 13 wherein the processor is adapted to transform the image received by the receiver, on a pixel by pixel basis by transforming each pixel from RGB space into CIE xy co-ordinates; calculating an associated wavelength of the pixel; and identifying areas of similar spectrum and isolating those areas.

15. An apparatus according to claim 7 wherein the electro-magnetic radiation is visible radiation.

16. An apparatus according to claim 7 wherein the electro-magnetic radiation is invisible radiation preferably infrared radiation.

17. An apparatus according to claim 7 further comprising a lens for forming an image of the distal end of the probe on the object.

18. A method for determining the shape of an object comprising the steps of:
a) illuminating the object with electro-magnetic radiation comprising spectrally distinct features to form an image;
b) receiving reflected light from the image;
c) determining the shape of the object from data generated from the reflected light.

19. A method according to claim 18 wherein the step of determining the shape of the object comprises the steps of:
a) receiving data from the image in the form of pixels in RGB space;
b) converting the RGB space data into CIE xy coordinates;
c) calculating an associated wavelength of each pixel; identifying areas of constant wavelength and isolating those areas to form spots.
d) matching each spot with a corresponding ray in a calibrated dataset for 3D triangulation.
